(19) United States
(12) Patent Application Publication
(10) Pub. No.: US 2010/0232855 A1
(43) Pub. Date: Sep. 16, 2010

(54) DOUBLE-SURFACE IMAGE FORMING APPARATUS

(75) Inventors: Kunihiro KAWACHI, Tokyo (JP); Kyoichi MIZUNO, Tokyo (JP); Masahiro MATSUO, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/719,919

(22) Filed: Mar. 9, 2010

(30) Foreign Application Priority Data
Mar. 12, 2009 (JP) 2009-059329

(51) Int. Cl. G03G 15/20

(52) U.S. Cl. 399/401

(57) ABSTRACT

A double-surface image forming apparatus, including: an image carrier; a registration section; an image fixing device; a sheet recirculating supplying section; a sheet reversing section, arranged on a path of the sheet recirculating supplying section, to reverse the recording sheet from the front surface to a reverse surface by a switch-back conveyance; and a sheet rotating device, arranged on a path of the sheet recirculating supplying section, to stop the sheet at a predetermined position and to rotate the stopped sheet 180° in the sheet conveying direction, wherein the sheet rotating device includes; a positive rotation conveying section; a positive-negative rotation conveying section to rotate the sheet to the sheet conveying direction and to an opposite direction of the sheet conveying direction; and a rotation center nipping section, arranged to meet a position of the rotation center of the sheet, to support the sheet.

### CROSS REFERENCE TO RELATED APPLICATION

This application is based on Japanese Patent Application No. 2009-059,329 filed on Mar. 12, 2009 with the Japanese Patent Office, the entire content of which is hereby incorporated by reference.

### TECHNICAL FIELD

The present invention relates to a double-surface image forming apparatus to form images on both surfaces of a recording sheet.

### BACKGROUND OF THE INVENTION

In recent years, concerning a method of double-surface image formation, it is well-known that firstly, the image, formed on an image carrier, is transferred onto a front surface of the recording sheet to be fixed thereon, after that, the recording sheet, carrying the image on its front surface, is reversed at a sheet reversing section, said recording sheet is subsequently conveyed to the image carrier to receive a next image on its reverse surface in predetermined timing.

As a structure to reverse the recording sheet, a switch-back conveyance is well-known, in which after the recording sheet, carrying the image on its front surface, is conveyed to a switch-back route, the conveying direction of the recording sheet is changed so that the conventional trailing edge of the recording sheet is turned to become new leading edge, and the recording sheet is again conveyed to the image forming section, where the next image is formed on the reverse surface of the recording sheet, which method has been disclosed by Unexamined Japanese Patent Application Publication Number 6-35,265.

However, there is another case for the recording sheets in which the leading edge and the trailing edge of the recording sheet are not always perpendicular to the side edges of the recording sheet. If such abnormal recording sheets are conveyed to the switch-back route for the double-surface image formation, and when the recording sheet is registered to meet timing of the image formation by paired registration rollers, the images are formed obliquely between both surfaces at a position of said rollers, whereby positions of the images formed on both surfaces may differ to each other, due to the oblique images, that is a positional difference between the images of both surfaces. Said positional difference becomes a great problem, when a book-binding process is to be conducted in a post-processing operation.

In order to overcome the above problem, Unexamined Japanese Patent Application Publication Number 2002-20,000 discloses a technology in that when the double-surface image formation is conducted, the leading edge of the recording sheet is not changed to a trailing edge, and paired endless belts are twisted 180° to be entrained about paired rollers, so that the recording sheet is reversed.

However, according to the above technology, the recording sheet is turned around a rotational center, being in the sheet conveying direction, and the rotational direction is perpendicular to the sheet conveying direction, whereby various technical problems occur. For example, a large space is necessary for a sheet reversing operation within the apparatus, high-speed sheet conveyance is difficult, and thin recording sheets tend to be folded or creased.

An aspect of the present invention is to overcome the above problems and to offer a double-surface image forming apparatus, in which the leading edge of the recording sheet is not changed to the trailing edge during the double-surface image formation, and the recording sheets are not folded nor creased within a small space, so that the recording sheet can be conveyed at high speed.

### SUMMARY OF THE INVENTION

The aspect will be attained by the invention detailed below.

A double-surface image forming apparatus, including: an image carrier to carry a toner image; a registration section at which a leading edge of a recording sheet conveying in a sheet conveying direction is stopped to time a sheet conveying timing, when the image carried on the image carrier is transferred to the recording sheet; an image fixing device to permanently fix the image transferred onto the recording sheet; a sheet recirculating supplying section to introduce the recording sheet which carries the image on a front surface, when the image is to be transferred to a reverse surface, wherein the sheet recirculating supplying section is arranged downstream of the image fixing device, and upstream of the registration section, in a sheet conveying direction; a sheet reversing section, arranged on a path of the sheet recirculating supplying section, to reverse the recording sheet from the front surface to a reverse surface by a switch-back conveyance; and a sheet rotating device, arranged on a path of the sheet recirculating supplying section, to stop the recording sheet at a predetermined position and to rotate the stopped recording sheet 180° in the sheet conveying direction, wherein the sheet rotating device includes; a positive rotation conveying section, to rotate the recording sheet to the sheet conveying direction; a positive-negative rotation conveying section to rotate the recording sheet to the sheet conveying direction and to an opposite direction of the sheet conveying direction, wherein both of the positive rotation conveying section and the positive-negative rotation conveying section are mounted on positions which are separated at an equal distance from a rotation center of the recording sheet to be rotated at the predetermined position, to sandwich the rotation center, and to be perpendicular to the sheet conveying direction; and a rotation center nipping section, arranged to meet a position of the rotation center of the recording sheet, to support the recording sheet, wherein when the recording sheet has arrived at the predetermined position, the positive rotation conveying section is rotated in a positive direction, and the positive-negative rotation conveying section is simultaneously rotated in a negative direction, so that the recording sheet is rotated 180° around the rotation center of the recording sheet supported by the rotation center nipping section, whereby the leading edge of the front surface of the recording sheet to be stopped at the registration section in the sheet conveying direction is registered to be equal to the leading edge of the reverse surface of the recording sheet to be stopped at the registration section in the sheet conveying direction.

### BRIEF DESCRIPTION OF THE DRAWINGS

Embodiments will now be described, by way of example only, with reference to the accompanying drawings which are meant to be exemplary, not limiting, and wherein like elements are numbered alike in the several figures, in which:

FIG. 1 is an overall schematic drawing of the double-surface image forming apparatus relating to embodiments of the present invention;

FIG. 2 is a schematic drawing to detail a structure and an operation of Embodiment 1 of sheet rotating device 30 relating to the present invention;

FIG. 3 is a schematic drawing to detail a structure and an operation of Embodiment 2 of sheet rotating device 30 relating to the present invention;

FIG. 4 is a schematic drawing to detail a structure and an operation of Embodiment 3 of sheet rotating device 30 relating to the present invention;

FIG. 5 is a schematic drawing to detail a structure and an operation of Embodiment 4 of sheet rotating device 30 relating to the present invention;

FIGS. 6a, 6b, 6c and 6d are cross-sectional drawings to show various examples of first members, included in paired sheet-nipping members relating to the present invention;

FIGS. 7a, 7b, 7c, 7d and 7e are cross-sectional drawings to show various examples of second members, included in paired sheet-nipping members relating to the present invention;

FIGS. 8a and 8b detail the rotating operations of sheet P, wherein sheet rotating device 30 relating to the present invention is arranged upstream or downstream of sheet reversing section 40;

FIG. 9 details the rotating operations of sheet P, wherein sheet rotating device 30 relating to the present invention is arranged within sheet reversing section 40;

FIG. 10 is a block diagram to show a control system of sheet rotating device 30 relating to the present invention;

FIG. 11 is a flow chart of a procedure of the operations of Embodiments 1 and 3 of sheet rotating device 30 relating to the present invention; and

FIG. 12 is a flow chart of a procedure of the operations of Embodiments 2 and 4 of sheet rotating device 30 relating to the present invention.

### DETAILED DESCRIPTIONS OF THE PREFERRED EMBODIMENTS

The embodiments of the present invention will now be detailed while referring to the drawings, but the present invention is not limited to the embodiments detailed below.

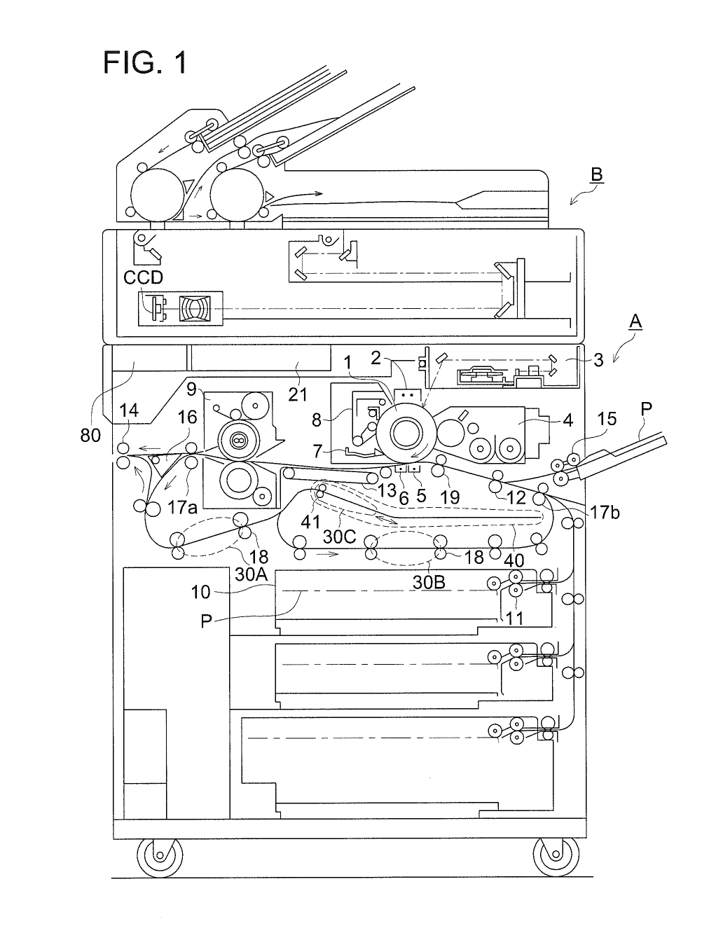

FIG. 1 is a schematic drawing of the double-surface image forming apparatus, structured of image forming apparatus A and document reading section B.

Image forming apparatus A is structured of: an image forming section which includes image carrier (being a photoconductive drum) 1, electronic charging section 2, image exposure section (being image writing section) 3, developing section 4, transfer section 5, discharging section 6, sheet separation claw 7, and cleaning section 8; image fixing section 9; and a sheet conveyance system.

Said sheet conveyance system is structured of: a first sheet conveyance section which is structured of sheet supplying cassette 10, first sheet supplying section 11, second sheet supplying section 12, sheet conveyance section 13, sheet ejection section 14, and manual sheet supplying section 15; sheet reversing section 40; sheet rotating device 30; and a sheet recirculating supplying section which re-supplies sheet P.

Both sheet supplying cassette 10 and first sheet supplying section 11 are structured of plural sheet supplying sections (which are shown by three stages on the bottom of FIG. 1), so that plural sizes of sheets P can be accommodated and supplied. The size of sheet P is manually inputted by the operator via operation section 21, or automatically inputted via a sheet-size detecting section.

Image data of the original document, read by document reading section B, are read by image sensor CCD. Analog signals, photo-electrically transferred by image sensor CCD, are processed in an image processing section with regard to the analog process, A/D conversion, shading correction, and image compression, after that, said processed signals are sent to exposure section 3.

On image exposure section 3, laser rays, generated by a semiconductor laser, are exposed onto image carrier 1 of the image forming section, so that latent images are formed. On the image forming section, electrical charging, an exposure operation, a development operation, an image transfer operation, sheet separation, and a cleaning operation are conducted. The latent images formed on image carrier 1 are developed to become toner images by development section 4. Sheet P, supplied from sheet supplying cassette 10 or manual sheet supplying section 15, is subsequently conveyed by paired registration rollers 19 to image transfer section 5, so that sheet P can precisely meet the toner images carried on image carrier 1, whereby the toner images are transferred onto sheet P by image transfer section 5. After that, sheet P, carrying the transferred toner images, is permanently fixed by image fixing section 9, and is ejected from sheet ejection section 14.

As another conveying path, sheet P, carrying the processed images on its front surface, and conveyed to the circulation re-supplying section by conveying path switching section 16, is reversed by paired reverse rotation conveying rollers 41 on sheet reversing section 40, employing a so-called switch-back conveyance, after that, sheet P receives images on its reverse surface at the image forming section. The above described circulation re-supplying section is a closed loop sheet conveying path, structured of: conveying roller 17a mounted downstream of image fixing section 9 in a sheet conveying direction; conveying path switching section 16; areas 30A, 30B and 30C; and conveying roller 17b mounted upstream of registration rollers 19.

Sheet P, carrying images on both its surfaces, is sent to image fixing section, where the images are fixed, and sheet P is then ejected by sheet ejection section 14.

The operations of various sections of image forming apparatus A and document reading section B are controlled by control section 80, provided on image forming apparatus A.

Sheet rotating device 30, which is configured to rotate sheet P 180° from an original conveying direction, relating to the present invention, is provided on area 30A, 30B or 30C, within the circulation re-supplying section, being upstream of paired registration rollers 19, and downstream of image fixing section 9, in the sheet conveying direction. In more detail, sheet rotating device 30 is configured to rotate sheet P 180° from the original conveying direction on the same plane, and change the conveying direction of sheet P to an opposite direction. Sheet reversing section 40 is also provided within the sheet recirculating supplying section.

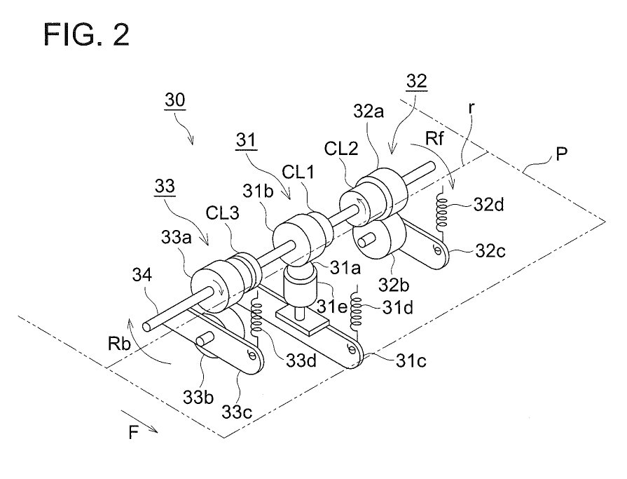

FIG. 2 is a schematic drawing to detail a structure and an operation of Embodiment 1 of sheet rotating device 30 relating to the present invention.

Sheet rotating device 30 is mounted on a center position of sheet P in its width direction, being perpendicular to sheet conveying direction F. Embodiment 1 concerning sheet rotating device 30 is structured of rotational-center nipping unit 31, positive rotation conveying roller unit 32, positive-negative rotation conveying roller unit 33, and drive shaft 34.

Rotational-center nipping unit 31 relating to the present invention is structured of positive rotation conveying roller 31b and spherical member 31a, both paired to serve as a sheet nipping member to always nip sheet P being conveyed, holding member 31e, lever 31c, and spring 31d. Positive rotation conveying roller 31b is coupled to clutch CL1, and clutch CL1 is coupled to driving shaft 34, so that positive rotation conveying roller 31b is driven in the positive direction, when clutch CL1 is activated. In addition, by the positive rotation, sheet P is carried in sheet conveying direction F, and by the negative rotation, sheet P is carried in an opposite direction of sheet conveying direction F. Spherical member 31a is supported by holding member 31e, to be rotatable, in all directions.

Positive rotation conveying roller unit 32, and positive-negative rotation conveying roller unit 33, relating to the present invention, are mounted to be separated to each other at the same distance from a center position with regard to the width direction of the sheet to be conveyed, in which said width direction is perpendicular to the sheet conveyance direction. That is, rotational-center nipping unit 31 is arranged on a center position between positive rotation conveying roller unit 32 and positive-negative rotation conveying roller unit 33.

Positive rotation conveying roller unit 32 is structured of positive rotation drive roller 32a, positive rotation driven roller 32b, clutch CL2, lever 32c, and spring member 32d, wherein positive rotation drive roller 32a is coupled to drive shaft 34 via clutch CL2. Positive-negative rotation conveying roller unit 33 is structured of positive-negative rotation drive roller 33a, positive-negative rotation driven roller 33b, clutch CL3 which is changeable between the positive and negative rotations, lever 33c, and spring member 33d, wherein positive-negative rotation drive roller 33a is engaged to drive shaft 34 via clutch CL3. Clutches CL1 and CL2 are coupled to drive shaft 34, which rotates in the positive direction, whereby, based on instructions from control section 80, clutches CL1 and CL2 are activated or deactivated, so that said clutches allow positive direction rotating rollers 31b and 32a to rotate in the positive direction or to stop rotation. Further, CL3 is coupled to drive shaft 34, which rotates in the positive direction, whereby, based on instructions from control section 80, clutch CL3 is activated or deactivated, so that said clutch allows positive-negative direction rotating roller 33a to be rotated in the positive or negative direction, or to stop rotation.

Spherical member 31a, serving as a first member included in the paired sheet-nipping members, is supported by holding member 31e to rotate in all directions, and holding member 31e is mounted on lever 31c, wherein lever 31c is pulled by spring member 31d. Positive rotation drive roller 31b, serving as a second member included in the paired sheet-nipping members, nips conveying sheet P with spherical member 31a. Since holding member 31e is mounted on lever 31c, spherical member 31a is pushed toward drive roller 31b to nip sheet P. Spherical member 31a and positive direction drive roller 31b, both serving as the paired sheet-nipping members of the present embodiment, always nip sheet P, if a sheet P exists in between.

Positive direction driven roller 32b is mounted on lever 32c via a shaft (whose indicating number is not shown in FIG. 2). Since lever 32c is pulled upward by spring member 32d, positive direction driven roller 32b is always pushed against positive direction drive roller 32a. In the same manner, positive-negative direction driven roller 33b is mounted on lever 33c via a shaft (whose indicating number is not shown in FIG. 2). Since lever 33c is pulled upward by spring member 33d, positive-negative direction driven roller 33b is always pushed against positive-negative direction drive roller 33a.

Operation of sheet rotating device 30 relating to the present invention will now be detailed while referring to FIG. 2.

In FIG. 1, after sheet P, carrying the image on its front surface, is processed by image fixing section 9, sheet P is directed to the sheet recirculating supplying section by conveying path switching section 16 via paired conveying rollers 17a, and sheet P is subsequently conveyed to a predetermined position of sheet rotating device 30, on which sheet P is to be rotated 180°, wherein sheet rotating device 30 is mounted on any one of areas 30A, 30B, and 30C, as detailed above. In FIG. 2, control section 80 controls clutches CL1, CL2 and CL3 to engage drive shaft 34, so that positive rotation conveying rollers 31b and 32a and positive-negative rotation conveying roller 33a rotate in the positive direction. When sheet P reaches the predetermined position, sheet P is detected by sheet detector SA, which is not illustrated, whereby control section 80 control CL1, CL2 and CL3 to disengage driving shaft 34, so that sheet P is stopped. Sheet detector SA functions to detect whether sheet P has been conveyed to the predetermined position on sheet rotating position 30. Accordingly, when sheet P stops at the predetermined position, the rotating center of sheet P exists on a center position of line “r”, which line “r” is perpendicular to sheet conveying direction F in FIG. 2, and said center position just meets a top of spherical member 31a being in contact with rotational-center nipping unit 31. Subsequently, clutches CL2 and CL3 are activated, so that clutch CL2 rotates positive rotation conveying roller 32a in the positive direction, and clutch CL3 rotates positive-negative rotation conveying roller 33a in the negative direction. Since the rotational center of sheet P is nipped between positive rotation conveying rollers 31b and spherical member 31a, sheet P rotates in the arrowed direction Rf in FIG. 2, due to the rotation of positive rotation conveying roller 32a, and simultaneously sheet P receives a rotational force in the arrowed direction Rb, due to the rotation of positive-negative rotation conveying roller 33a. Sheet P still rotates around the rotational center nipped between positive rotation conveying rollers 31b and the top of spherical member 31a, and after 180° rotation, control section 80 controls clutches CL2 and CL3 to disengage to drive shaft 34 by a signal sent from sheet detector SB, which is not illustrated. That is, sheet P has been rotated 180° in the sheet conveying direction. Subsequently, control section again activates clutches CL1, CL2 and CL3, sheet P is conveyed by rotational center nipping unit 31, positive rotation roller unit 32, and positive-negative rotation roller unit 33 each shown in FIG. 2, to paired conveying rollers 17b shown in FIG. 1. Sheet P is then controlled to adjust image transfer timing by paired registration rollers 19, and conveyed to image transfer section 5 to receive the image on its reverse surface.

Based on Embodiment 1 of sheet rotating device 30 relating to the present invention, the sheet can be rapidly and precisely rotated 180° in the sheet conveying direction by the simple structure, whereby the leading edges to be pushed to paired registration rollers 19 are uniformed, when the images are to be formed on both surfaces. Further, if a guide plate is used, a thin sheet or a soft sheet can be stably rotated, whereby folding or crease is not produced. Still further, since spherical member 31a can rotate in all directions, spherical member 31a rotates in sheet conveying direction F while the sheet is conveyed, and spherical member 31a rotates to follow the sheet in sheet rotating directions Rf and Rb while the sheet is rotated, whereby the sheet conveying operation and the sheet rotating operation are smoothly performed.

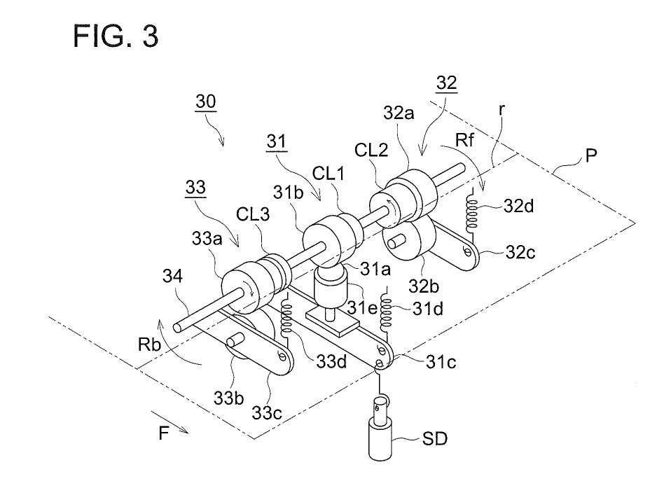

FIG. 3 is a schematic drawing to detail a structure and an operation of Embodiment 2 of sheet rotating device 30 relating to the present invention.

Embodiment 2 is similar to Embodiment 1, so that the same numbers are applied to sections and components of Embodiment 2 which have the same function as those of Embodiment 1, and redundant explanations are omitted. Different structure and operation between Embodiments 1 and 2 are detailed below.

A different structure is that, positive rotation conveying roller 31b and spherical member 31a are structured to be able to release the pressure contact with sheet P in Embodiment 2. That is, in Embodiment 2, solenoid SD, serving as a pressure contact releasing member, is connected to lever 31c. After sheet P is completely rotated, solenoid SD releases spherical member 31a from positive rotation conveying roller 31b via lever 31c, countering spring member 31d. When subsequent sheet P is to be conveyed, solenoid SD is activated to pull lever 31c, until said subsequent sheet P arrives at the predetermined position of sheet rotating device 30. When said subsequent sheet P is to be rotated at the predetermined position, solenoid SD is deactivated so that spherical member 31a is pressed again against positive rotation conveying roller 31b via spring member 31d.

In Embodiment 2, the pressure contact between spherical member 31a and positive rotation conveying roller 31b is performed by spring member 31d, and the releasing operation is performed by solenoid SD, however, spring member 31d can be interchanged to solenoid SD. That is, while sheet P is rotated, the pressure contact is performed by solenoid SD, and after sheet P is completely rotated, solenoid SD is deactivated, so that spring member 31d releases sheet P.

Further, in Embodiment 2, the second member, to nip sheet P with spherical member 31a, represents positive rotation conveying roller 31b. Since said second member to be engaged with spherical member 31a is released during sheet conveyance, said second member is not needed to be a rotatable roller, so that said member can be a non-rotatable fixed member. Because spherical member 31a is separated from sheet P during the sheet conveyance, sheet P is conveyed to rub a surface of the fixed member, and spherical member 31a nips the rotating center of sheet P with said fixed member, during the sheet rotation.

Based on Embodiment 2 of sheet rotating device 30 relating to the present invention, since rotation center nipping unit 31 and spherical member 31a do not come into pressure contact with sheet P, during sheet conveyance, they do not adversely influence the sheet conveyance.

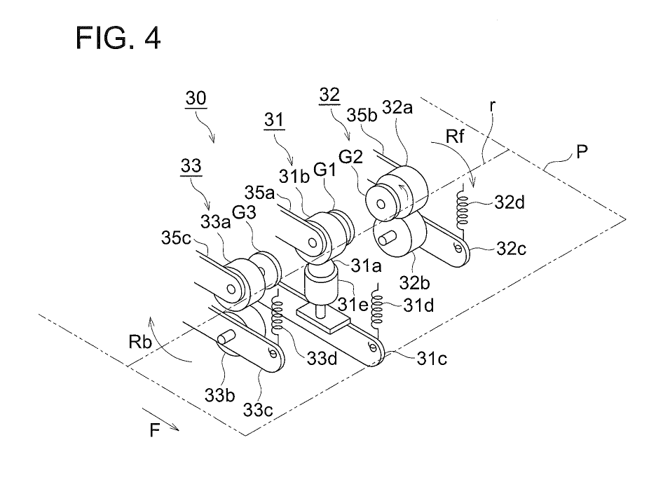

FIG. 4 is a schematic drawing to detail a structure and an operation of Embodiment 3 of sheet rotating device 30 relating to the present invention.

Embodiment 3 is similar to Embodiment 1, so that the same numbers are applied to sections and components of Embodiment 3 which have the same function as those of Embodiment 1, and redundant explanations are omitted. Different structure and operations between Embodiments 1 and 3 are detailed below.

A different structure between Embodiment 1 and Embodiment 3 is that positive rotation conveying rollers 31b and 32a are driven via the clutches in Embodiment 1, while positive rotation conveying rollers 31b and 32a are driven via respective motors in Embodiment 3. That is, in Embodiment 3, the rotational center nipping unit is structured of spherical member 31a and positive rotation drive roller 31b, both always nip sheet P, wherein positive rotation drive roller 31b is driven by a motor, which is not illustrated, through gear G1. Said motor is controlled by control section 80, so that positive rotation drive roller 31b is rotated in the positive direction or stopped by gear G.

Another different structure between Embodiment 1 and Embodiment 3 is that, rotational center nipping unit 31, positive rotation conveying roller unit 32, and positive-negative rotation conveying roller unit 33 are supported by drive shaft 34 in Embodiment 1, while units 31, 32 and 33 are supported by supporting members 35a, 35b and 35c, respectively.

Positive rotation conveying roller unit 32, which serves as a positive rotation conveying section in the present invention, is structured of positive rotation drive roller 32a, positive rotation driven roller 32b, and drive gear G2, wherein positive rotation drive roller 32a is connected to a drive motor, which is not illustrated, via drive gear G2. Said drive motor is controlled by control section 80, so that positive rotation drive roller 32a is rotated in the positive direction or stopped. Positive-negative rotation conveying roller unit 33, which serves as a positive-negative rotation conveying section in the present invention, is structured of positive-negative rotation drive roller 33a, positive-negative rotation driven roller 33b, and drive gear G3, wherein positive-negative rotation drive roller 33a is connected to a drive motor, which is not illustrated, via drive gear G3. Said drive motor is controlled by control section 80, so that positive rotation drive roller 33a is rotated in the positive direction, or rotated in the negative direction, or stopped, by the instruction sent from control section 80. A total of three drive motors, described above, are individually controlled by control section 80.

Sheet rotating device 30 relating to Embodiment 3 will now be detailed, while referring to FIG. 4.

When sheet P reaches the predetermined position of sheet rotating device 30, sheet P is detected by sensor SA, which is not illustrated, whereby control section 80 controls the above described three motors, which are not illustrated, to stop their respective rotations, so that gears G1, G2, and G3 are stopped, and sheet P is stopped. At this time, the position of the rotating center of sheet P meets the top of spherical member 31a, which is the same as in the case of Embodiment 1. After that, two motors, which are connected to gear G2 and G3 respectively, are activated, so that positive rotation conveying roller 32a is rotated in the positive direction, and simultaneously positive-negative rotation conveying roller 33a is rotated in the negative direction.

Since the rotational center of sheet P is nipped between rotational-center nipping unit 31 and spherical member 31a, sheet P rotates in the arrowed direction Rf in FIG. 4, due to the rotation of positive rotation conveying roller 32a, and simultaneously sheet P receives a rotational force in the arrowed direction Rb, due to the rotation of positive-negative rotation conveying roller 32a. Sheet P still rotates around the rotational center nipped between rotational-center nipping unit 31 and the top of spherical member 31a, and after 180° rotation, control section 80 receives a signal sent from sheet detector SB, which is not illustrated, to stop the drive motors, whereby the rotation of sheet P is stopped. Spherical member 31a and positive rotation drive roller 31b always nip sheet P, while sheet P exists between them.

Based on Embodiment 3 of sheet rotating device 30 relating to the present invention, rotational-center nipping unit 31, positive rotation conveying roller unit 32, and positive-negative rotation conveying roller unit 33 are driven with higher reliability by their respective motors. Further, since a driving shaft, extending in the sheet width direction, is not necessary in Embodiment 3, so that wide spaces are obtained.

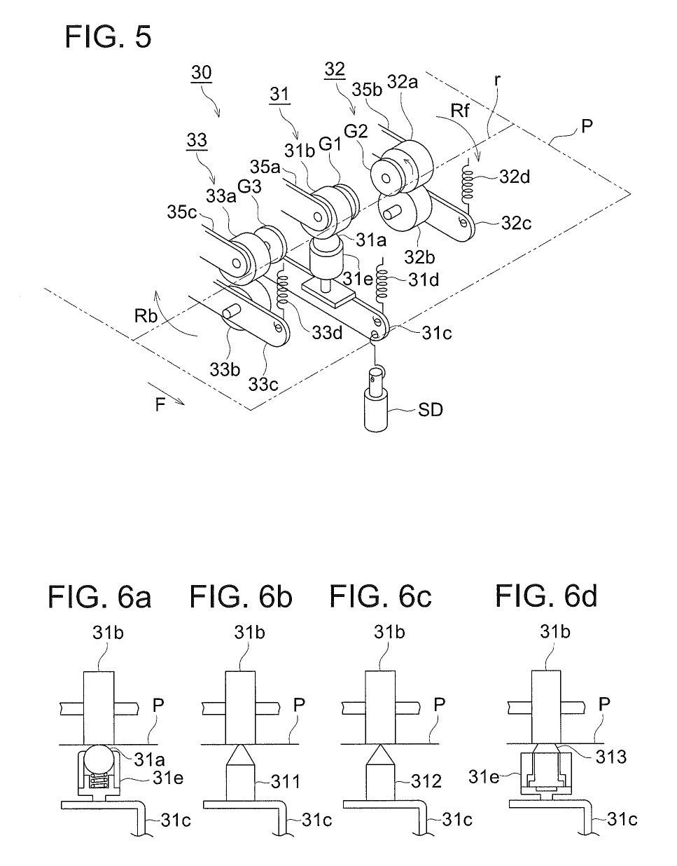

FIG. 5 is a schematic drawing to detail a structure and an operation of Embodiment 4 of sheet rotating device 30 relating to the present invention.

Embodiment 4 is similar to Embodiment 3, so that the same numbers are applied to sections and components of Embodiment 4 which have the same function as those of Embodiment 3, and redundant explanations are omitted. Different structure and operation between Embodiments 3 and 4 are detailed below.

A different structure is that, spherical member 31a is structured to release the pressure contact with sheet P in Embodiment 4. That is, in Embodiment 4, solenoid SD is connected to lever 31c. After sheet P is completely rotated, solenoid SD releases spherical member 31a from positive rotation conveying roller 31b via lever 31c, countering spring member 31d. When subsequent sheet P is to be conveyed, solenoid SD is activated to pull lever 31c, until said subsequent sheet P arrives at the predetermined position of sheet rotating device 30. When sheet P is to be rotated at the predetermined position, solenoid SD is deactivated so that spherical member 31a is pressed against positive rotation conveying roller 31b via spring member 31d. Further, during sheet conveyance, rotational-center nipping unit 31 is released from sheet P by solenoid SD, it is not necessary for positive rotation conveying roller 31b to be driven by the motor, which is a different structure from Embodiment 3, so that gear G1, coupling to positive rotation conveying roller 31b, and the motor to drive positive rotation conveying roller 31b are not necessary in Embodiment 4. That is, positive rotation conveying roller 31b in Embodiment 4 represents a rotatable roller, which is not driven.

In Embodiment 4, in the same way as in Embodiment 2, the pressure contact between spherical member 31a and positive rotation conveying roller 31b is performed by spring member 31d, and the releasing operation is performed by solenoid SD, however, spring member 31d can be interchanged with solenoid SD. Further, in the same way as in Embodiment 2, the second member to come into contact with spherical member 31a, serving as the first member, may be a non-rotatable fixed member.

Based on Embodiment 4 of sheet rotating device 30 relating to the present invention, spherical member 31a is separated from sheet P during sheet conveyance, which is the same way as in Embodiment 2, spherical member 31a does not adversely influence the sheet conveyance. Further, by the same structure as in Embodiment 3, reliable operation and wide spaces are obtained.

In Embodiments 1-4, respective conveying rollers are used for positive rotation conveying roller unit 32, and positive-negative rotation conveying roller unit 33. Instead, conveying belts can be used for them. Sheet conveyance using the belt is a well known structure, and a structure, which employs a rotational-center nipping means in a center, and two conveying belts to rotate in the opposite directions in sheet width directions, is similar to the present Embodiments, whereby the explanation of said structure is omitted.

In above described Embodiments 1-4 of sheet rotating device 30 relating to the present invention, spherical member 31a, serving as the first member included in the paired sheet-nipping members, is used for the sheet nipping members, but instead of the spherical member, other members can be used.

FIGS. 6a-6d show cross-sectional drawings to show various examples of the first members included in the paired sheet-nipping members relating to the present invention.

Each first member, included in the paired sheet-nipping members, represents a member to be provided under sheet P. Each second member, included in the paired sheet-nipping members, represents positive rotation conveying roller 31b, to be provided above sheet P. In FIG. 6a, spherical members 31a of Embodiments 1-4 are used as said first members. In FIG. 6b, a small rounded-point top member is mounted on a protruding member. In FIG. 6c, a sharp conical member or a sharp pyramid member is provided to come into contact with sheet P. In FIG. 6d, a rotatable member is mounted, which member is supported rotatably in the same direction as the surface of rotating sheet P.

In FIG. 6a, spherical member 31a is supported by holding member 31e, so that spherical member 31a rotates in all directions. When sheet P is conveyed, spherical member 31a is rotated to follow conveying sheet P which is conveyed by positive rotation conveying roller 31b, and when sheet P is rotated, spherical member 31a is rotated by following sheet P which is rotated by positive rotation drive roller 32a and positive-negative rotation drive roller 33a.

In FIG. 6a, in order to improve manufacturing accuracy of mechanical parts used for spherical member 31a and holding member 31e, and to attain a smooth rotational effect, a spring member (its reference number is not shown) is provided within holding member 31e, so that the spring member presses spherical member 31a against sheet P, whereby it is possible for this example not to use said spring. Further, when spherical member 31a is to be used as the first member of paired sheet-nipping members, if an image forming surface of sheet P is set to face spherical member 31a, the toner images on sheet P are not deteriorated by the friction between rotating sheet P and positive rotation conveying roller 31b.

In FIG. 6b, numeral 311 represents a member having the small rounded-point top member on its top, so that said rounded-point top member is preferably formed of a metal or a rigid plastic, exhibiting a low frictional factor. In FIG. 6c, numeral 312 represents a member having the sharp top member. In FIG. 6d, numeral 313 represents the rotatable member, rotatably supported in the direction of the surface of sheet P which is to be conveyed to the predetermined position. Rotatable member 313 is rotatably supported by holding member 31e.

In Embodiments 1 and 3 of sheet rotating device 30, since the paired sheet-nipping members are configured to be in contact with sheet P during the sheet conveyance, spherical member 31a shown in FIG. 6a and rounded-point top member 311 shown in FIG. 6b are preferably used. In Embodiments 2 and 4, since the paired sheet-nipping members are configured to be separated from sheet P, every member shown in FIGS. 6a-6d can be used, but from a view point of sheet rotating friction, spherical member 31a shown in FIG. 6a and rotatable member 313 shown in FIG. 6d are preferably used.

Rounded-point top member 311, shown in FIG. 6b, and sharp top member 312, shown in FIG. 6c, are simple members so that their manufacturing cost is low. Further, sharp top member 312, shown in FIG. 6c, can nip sheet P more precisely at the rotating center than rounded-point top member 311 shown in FIG. 6b does, but sharp top member 312 tends to scratch sheet P. Rotatable member 313, shown in FIG. 6d, is produced more easily than spherical member 31a shown in FIG. 6a is, and the manufacturing cost of rotatable member 313 is reduced.

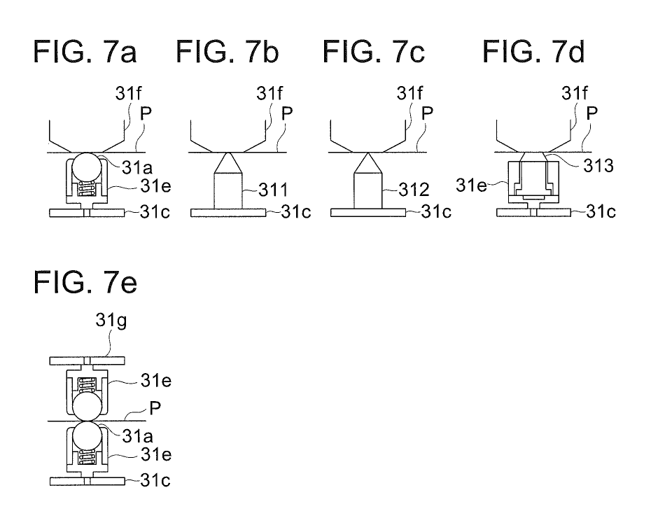

FIGS. 7a-7e are cross-sectional drawings to show various examples of the second members included in paired sheet-nipping members relating to the present invention.

The first members, included in paired sheet-nipping members, are provided under sheet P in FIGS. 7a-7d, being equal to the members shown in FIGS. 6a-6d.

The second members, included in paired sheet-nipping members, are provided above sheet P in FIGS. 7a-7d, wherein still members 31f, which are mounted on image forming apparatus A, are used, being different to positive rotation conveying rollers 31b in FIGS. 6a-6d. In FIG. 7e, spherical member 31a, used as the first member in FIG. 6a or FIG. 7a, is structured to be the second member of the paired sheet nipping members.

Concerning the first members included in the paired sheet-nipping members in FIGS. 7a-7d, they are structured to be the same as the structures shown in FIGS. 6a-6d, and the same numbers are applied to the same members, so that redundant explanations are omitted.

In FIG. 7a, if the first member of the paired sheet-nipping members represents spherical member 31a, since spherical member 31a is rotated by conveying sheet P in the sheet conveying direction during the sheet conveyance, still member 31f used in Embodiments 1-4 can be used.

In FIGS. 7b-7d, when the sheet is being nipped by the paired sheet-nipping members, still member 31f can be used for the sheet rotating operation, but when the sheet is to be conveyed, paired sheet-conveying members adversely function as the conveying frictions for the sheet conveyance, so that said members cannot be used, whereby the sheet must be released from the paired nipping members, during the sheet conveyance. Accordingly, the structures shown in FIGS. 7b-7d, are used for Embodiments 2 and 4, in which sheet-nipping is released, but are difficult to be used for Embodiments 1 and 3, in which sheet-nipping is not released.

In FIG. 7e, spherical member 31a is used, serving as the first member of the paired sheet-nipping members, shown in FIGS. 6a and 7a. Spherical member 31a is also used, serving as the second member. In this case, when sheet P is conveying, spherical member 31a is rotated by conveying sheet P, so that this structure can be used in Embodiments 1-4. Further when sheet P is conveying, both first and second members are rotated by conveying sheet P, so that sheet P can be conveyed without friction, and the image formed on the first surface is not damaged during the sheet rotation.

Comparing FIGS. 7a-7d with FIGS. 6a-6d, each second member is not positive rotation conveying roller 31b in FIGS. 7a-7d, but it is still member 31f, which is simple, exhibiting low production cost. Further in FIG. 7e, the first member is equal to the second member, which is also a simple structure.

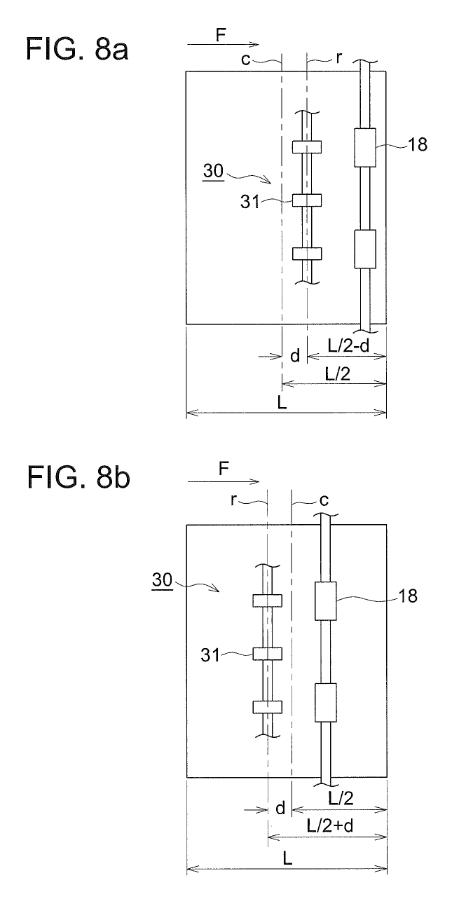

FIGS. 8a and 8b detail the rotating operations of sheet P, wherein sheet rotating device 30 relating to the present invention is arranged upstream or downstream of sheet reversing section 40.

Sheet rotating device 30 is arranged on area 30A which exists upstream of sheet reversing section 40 in sheet conveying direction F, or on area 30B which exists downstream of sheet reversing section 40 in sheet conveying direction F (See FIG. 1). Symbol “L” represents a length of sheet P in sheet conveying direction F, and symbol “c” represents a center line of sheet P, having length L. Symbol “r” represents a line perpendicular to sheet conveying direction F, wherein line “r” runs on the rotational center of sheet P (which is the position of spherical member 31a), when sheet P reaches the predetermined position on sheet rotating device 30 (said predetermined position represents a position where sheet P is rotated).

In FIG. 8a, sheet P has just arrived at the predetermined position on sheet rotating device 30, and sheet P is not yet rotated. In FIG. 8b, sheet P has been rotated 180° on the predetermined position. When sheet P is rotated, sheet P is released from conveying roller 18, provided on area 30A or 30B (See FIG. 1).

In FIG. 8a, the position of line “r” (which is the position of spherical member 31a) is set at a position downstream of center line “c” of sheet P, stopping at the predetermined position, in sheet conveying direction F, which will be detailed below.

In FIG. 8a, the distance between line “r” and center line “c” is represented by symbol “d”. The distance between line “r” and the leading edge of sheet P in sheet conveying direction F is shown by (L/2−d). In FIG. 8b, the distance between the rotational center and the leading edge of rotated sheet P, is shown by (L/2+d). Accordingly, after sheet P has been rotated, sheet P is conveyed [(L/2+d)−(L/2−d)=2d] in sheet conveying direction F, which is a problem.

That is, concerning sheet rotating device 30, which is arranged upstream or downstream of sheet reversing section 40, in the sheet conveying direction F, the predetermined position on sheet rotating device 30 should be determined, so that the position of the rotating center of sheet P (which is the position of line “r”) is determined to be downstream of center line “c” of sheet P in sheet conveying direction F. Because, between after and before the rotation, sheet P is conveyed “2d”, whereby the conveying time interval of sheet P can be decreased. However, if the position of line “r” is determined to be upstream of center line “c” of sheet P, having stopped at the predetermined position, in sheet conveying direction F, the leading edge of sheet P after the rotation is drawn back “2d” toward upstream in sheet conveying direction F, which is an adverse problem.

In FIG. 8, concerning sheet rotating device 30 to be mounted upstream or downstream of sheet reversing section 40, if the rotating center of sheet P is positioned to be more downstream than the center of sheet, the position of sheet before the rotation and the position of sheet after the rotation can be determined to be more downstream in sheet conveying direction F. That is, the necessary time interval for conveying sheet P can be reduced.

In the embodiment of sheet rotating device 30 shown in FIG. 8, a structure, in which conveying roller 18 is mounted on area 30A or area 30B, is detailed. Otherwise, a structure, in which conveying roller 18 is not included in area 30A or area 30B, can be used. In such the structure, when sheet P is rotated by sheet rotating device 30, sheet P, having been pressed against conveying roller 18, is not necessary to be released.

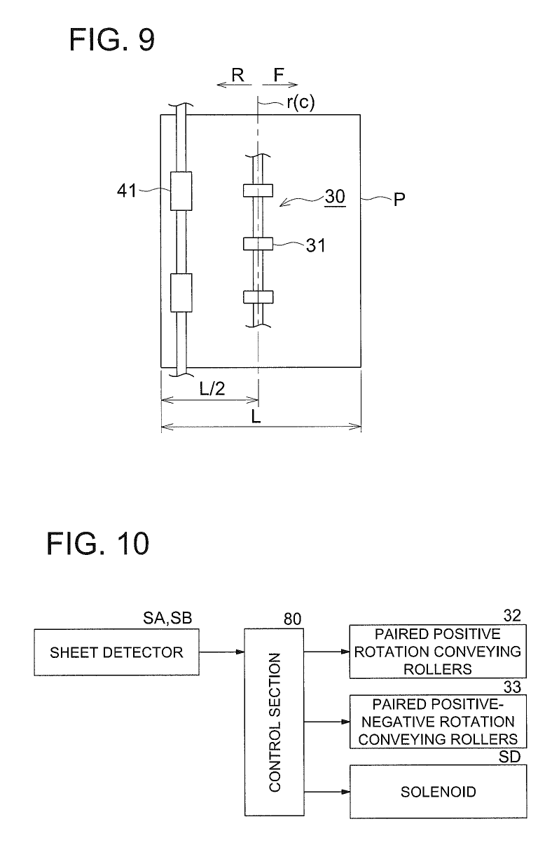

FIG. 9 details the rotation of sheet P in an embodiment in that sheet rotating device 30, relating to the present invention, is mounted within sheet reversing section 40.

In FIG. 9, sheet rotating device 30 is mounted in area 30C in sheet reversing section 40 (See FIG. 1). In this embodiment, when sheet P reaches a predetermined position on sheet rotating device 30, line “r” on the rotating center of sheet P is configured to be equal to center line “c” of sheet P, whereby the position of line “r” is equal to the position of spherical member 31a.

Further, in FIG. 9, the stopping position of sheet P is equal to the stopping position of sheet P of sheet reversing section 40, functioning a sheet switch-back method, which method does not include sheet rotating device 30. In sheet reversing section 40 functioning the sheet switch-back method, sheet P is conveyed to sheet reversing section 40 in direction F, and the leading edge of sheet P, being a left side of FIG. 9, is nipped by paired reverse rotation conveying rollers 41, so that sheet P stops. After that, sheet P is switched back from direction F to direction R, so that sheet P is reversed (See FIG. 1). The stopping position of sheet P shown in FIG. 9 is determined to be optimal and shortest, after a mounting position of a conveying path switching section, which is not illustrated, but to be mounted beyond paired reverse rotation conveying rollers 41 in direction R, is considered (Sheet S cannot be stopped at a position upstream of said stopping position, in sheet conveying direction F).

Accordingly, also in the structure in which sheet rotating device 30 of the present invention is mounted at area 30C within sheet reversing section 40, the predetermined stopping position of sheet P cannot be set at a position upstream of the position shown in FIG. 9 in sheet conveying direction F, in order to rotate sheet P. Further, if the predetermined position is set at a position downstream of the position shown in FIG. 9 in sheet conveying direction F, both of line “r”, representing the position of the rotating center of sheet P, and the position of sheet rotating device 30 shift to positions downstream of center line “c” of sheet P in sheet conveying direction F. If sheet P is rotated 180° at said position, center line “c” of sheet P is positioned more downstream of line “r”, whereby after sheet P is rotated, the position of sheet P is shifted downstream in sheet conveying direction F, at distance of “2d”, in which “d” represents a distance between line “r” and center line “c” of sheet P. That is, after sheet P is reversed, when sheet P is conveyed again by paired reverse rotation conveying rollers 41, sheet P is conveyed on a longer distance, using a longer time interval.

That is, in the case that sheet rotating device 30 is mounted in area 30C within sheet reversing section 40, in order not to generate the above problem, the predetermined position to rotate sheet P is the position on which line “r” is equal to center line “c” of sheet P in FIG. 9, which is an optimum position.

In FIG. 9, sheet P is nipped between rotation center nipping unit 31 and spherical member 31a, and rotated 180° by the rotations of positive rotation conveying roller 32a and positive-negative rotation conveying roller 33a, whereby sheet P stops at the same position as the position before the rotation, while the leading edge of sheet P is changed to the trailing edge. While sheet P is rotated, sheet P is released from paired reverse rotation conveying rollers 41. After that, sheet P is nipped by paired reverse rotation conveying rollers 41 to be conveyed, so that sheet P, having been reversed, is carried out from sheet rotating section 40 (See FIG. 1).

In FIG. 9, in sheet rotating device 30 which is mounted within sheet reversing section 40, since the position of the rotation center of sheet P during the rotation is set on the center of sheet P, the position of sheet P after the rotation does not change from the position before the rotation, so that sheet P is effectively rotated.

In the embodiment of sheet rotating device 30 shown in FIG. 9, the structure is detailed, in which paired reverse rotation conveying rollers 41 are mounted in area 30C. However, another structure is also possible for use, in which paired reverse rotation conveying rollers 41 are not included in area 30C. In such a case, sheet P is rotated by sheet rotating device 30, while being still pressed.

FIG. 10 shows a block diagram of a control system of sheet rotating device 30 relating to the present invention.

In FIG. 10, control section 80 controls various sections, based on signals from sheet detecting sensor SA to detect sheet P, having arrived at the predetermined position on sheet rotating device 30, and based on signals from sheet detecting sensor SB to detect sheet P, having arrived at the predetermined position after 180° rotation.

In Embodiments 1 and 3, when sheet detecting sensor SA detects sheet P, having arrived at the predetermined position, control section 80 continuously activates both positive rotation conveying roller unit 32 and positive-negative rotation conveying roller unit 33, so that sheet P is rotated. In Embodiments 2 and 4, control section 80 firstly activates solenoid SD so that sheet P is nipped by rotation center nipping unit 31, control section 80 subsequently activates both positive rotation conveying roller unit 32 and positive-negative rotation conveying roller unit 33, so that sheet P is rotated. In Embodiments 1 and 3, after sheet P has rotated 180°, control section 80 controls sheet detecting sensor SB to detect whether sheet P has arrived at the predetermined position. Based on the detected result, control section 80 controls both positive rotation conveying roller unit 32 and positive-negative rotation conveying roller unit 33, to stop rotation. In Embodiments 2 and 4, after sheet detecting sensor SB has detected the complete rotation of sheet P, control section 80 controls solenoid SD to release sheet P from rotation center nipping unit 31.

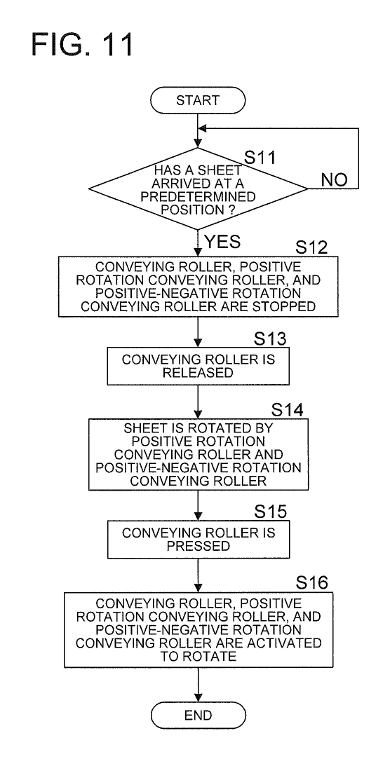

FIG. 11 shows a flow chart to detail the processing flow of Embodiments 1 and 3 of sheet rotating device 30 relating to the present invention.

In FIG. 11, firstly, sheet detecting sensor SA detects whether sheet P has arrived at the predetermined position on sheet rotating device 30 (which is step S11). If sheet P has not yet arrived at the predetermined position (No in step S11), the processing flow of FIG. 11 goes back to step S11, and sheet detecting sensor SA repeats to detect sheet P. When sensor SA detects sheet P having arrived (Yes in Step S11), the flow goes to step S12.

In step S12, control section 80 sends instructions to clutches CL1, CL2, and CL3, or the motors being not illustrated, not to rotate positive rotation conveying roller 31b, positive rotation conveying roller unit 32, and positive-negative rotation conveying roller unit 33, respectively. Simultaneously, control section 80 controls conveying roller 18 other than sheet rotating device 30, or paired reverse rotation conveying rollers 41 to stop their rotations (Step S12). Subsequently, control section 80 controls conveying roller 18 or paired reverse rotation conveying rollers 41, to release sheet P (Step S13).

Subsequently, control section 80 controls positive rotation conveying roller unit 32 to rotate in the positive direction, and controls positive-negative rotation conveying roller 33 to rotate in the negative direction, so that sheet P is rotated 180°. After that, sheet detecting sensor SB detects that sheet P has arrived at the predetermined position, whereby control section 80 controls both positive rotation conveying roller unit 32 and positive-negative rotation conveying roller unit 33, to stop their rotations (Step S14). After that, control section 80 controls conveying roller 18 or paired reverse rotation conveying rollers 41, to press against sheet P (Step S15).

Finally, control section 80 controls positive rotation conveying roller 31b, positive rotation conveying roller unit 32, and positive-negative rotation conveying roller unit 33, to rotate in the positive direction, so that sheet P is ejected from sheet rotating device 30 toward a next section (Step S16).

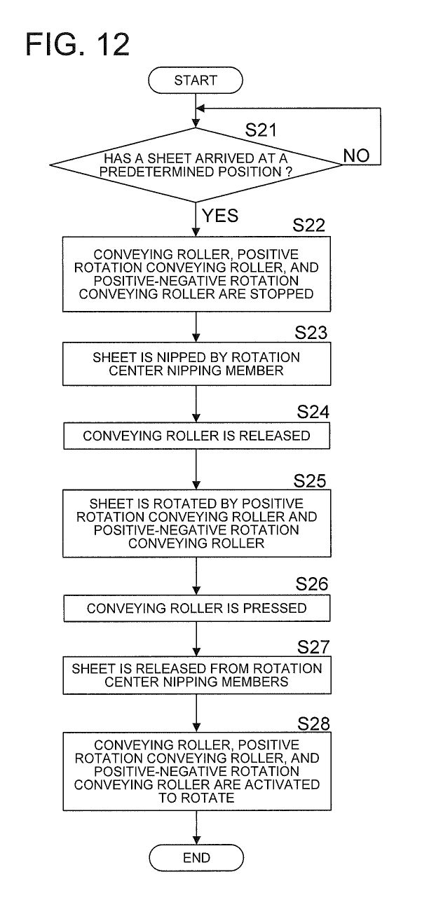

FIG. 12 shows a flow chart to detail the processing flow of Embodiments 2 and 4 of sheet rotating device 30 relating to the present invention.

In FIG. 12, firstly, sheet detecting sensor SA detects whether sheet P has arrived at the predetermined position on sheet rotating device 30 (which is step S21). If sheet P has arrived at the predetermined position (Yes in step S21), the processing flow of FIG. 12 goes to step S22, and if sheet P has not yet arrived at the predetermined position (No in step S21), the processing flow goes back to step S21, and sheet detecting sensor SA repeats to detect sheet P.

In step S22, control section 80 sends instructions to clutches CL1, CL2, and CL3, or the motors, not to rotate positive rotation conveying roller 31b, or positive rotation conveying roller unit 32, and positive-negative rotation conveying roller unit 33, respectively. Simultaneously, control section 80 controls conveying roller 18 or paired reverse rotation conveying rollers 41 to stop their rotations (Step S22). Subsequently, control section 80 controls solenoid SD to deactivate, so that spherical member 31a nips sheet P with positive rotation conveying roller 31b, through lever 31c (Step S23). Further, control section 80 controls conveying roller 18 or paired reverse rotation conveying rollers 41, to release sheet P (Step S24).

Subsequently, control section 80 controls positive rotation conveying roller unit 32 to rotate in the positive direction, and controls positive-negative rotation conveying roller 33 to rotate in the negative direction, so that sheet P is rotated 180°. After that, sheet detecting sensor SB detects that sheet P has arrived at the predetermined position, whereby control section 80 controls both positive rotation conveying roller unit 32 and positive-negative rotation conveying roller unit 33, to stop their rotations (Step S25). After that, control section 80 controls conveying roller 18 or paired reverse rotation conveying rollers 41, to press against sheet P (Step S26).

Subsequently, control section 80 controls solenoid SD to activate, so that spherical member 31a is separated from positive rotation conveying roller 31b through lever 31c (Step S27). Finally, control section 80 controls positive rotation conveying roller 31b or positive rotation conveying roller unit 32, and positive-negative rotation conveying roller unit 33, to rotate in the positive direction, so that sheet P is ejected from sheet rotating device 30 toward a next section (Step S28).

In the present flow charts, the flow of the structure is detailed, in which conveying roller 18 or paired reverse rotation conveying rollers 41 are mounted within the area where sheet P is rotated. However, a structure not mounting these rollers can be used, while step S24 is not necessary for use.

Concerning the effects of the present invention, when the images are formed on both surfaces of the recording sheet, the leading edges of both surfaces of the recording sheet are aligned to be equal by the registration section, so that the positions of the printed images on both surfaces are not shifted. Further, the recording sheet can be rotated at high speed within a small space. Still further, the thin sheet is not folded or creased.

While the preferred embodiments of the present invention have been described using specific terms, such description is for illustrative purpose only, and it is to be understood that changes and variations may be made without departing from the spirit and scope of the appended claims.

What is claimed is:

1. A double-surface image forming apparatus, comprising:
an image carrier to carry a toner image;
a registration section at which a leading edge of a recording sheet conveying in a sheet conveying direction is stopped to time a sheet conveying timing, when the image carried on the image carrier is transferred to the recording sheet;
an image fixing device to permanently fix the image transferred onto the recording sheet;
a sheet recirculating supplying section to introduce the recording sheet which carries the image on a front surface, when an image is to be transferred on a reverse surface, wherein the sheet recirculating supplying section is arranged downstream of the image fixing device, and upstream of the registration section, in a sheet conveying direction;
a sheet reversing section, arranged on a path of the sheet recirculating supplying section, to reverse the recording sheet from the front surface to the reverse surface by a switch-back conveyance; and
a sheet rotating device, arranged on a path of the sheet recirculating supplying section, to stop the recording sheet at a predetermined position and to rotate the stopped recording sheet 180° in the sheet conveying direction, wherein the sheet rotating device includes;
a positive rotation conveying section, to rotate the recording sheet to the sheet conveying direction;
a positive-negative rotation conveying section to rotate the recording sheet to the sheet conveying direction and to an opposite direction of the sheet conveying direction, wherein both of the positive rotation conveying section and the positive-negative rotation conveying section are mounted on positions which are separated at an equal distance from a rotation center of the recording sheet to be rotated at the predetermined position, to sandwich the rotation center, and to be perpendicular to the sheet conveying direction; and
a rotation center nipping section, arranged to meet a position of the rotation center of the recording sheet, to support the recording sheet,
wherein when the recording sheet has arrived at the predetermined position, the positive rotation conveying section is rotated in a positive direction, and the positive-negative rotation conveying section is simultaneously rotated in a negative direction, so that the recording sheet is rotated 180° around the rotation center of the recording sheet supported by the rotation center nipping section,
whereby the leading edge of the front surface of the recording sheet to be stopped at the registration section in the sheet conveying direction is registered to be equal to the leading edge of the reverse surface of the recording sheet to be stopped at the registration section in the sheet conveying direction.

2. The double-surface image forming apparatus of claim 1, wherein the rotation center nipping section has paired sheet nipping members including a first member and a second member, wherein the first member and the second member are configured to always nip the recording sheet, wherein the recording sheet has arrived at the predetermined position to be rotated.

3. The double-surface image forming apparatus of claim 2, wherein the first member included in the paired sheet nipping members comprises a rounded-point top member.

4. The double-surface image forming apparatus of claim 2, wherein the first member included in the paired sheet nipping members comprises a spherical member being supported to be rotatable in all directions.

5. The double-surface image forming apparatus of claim 2, wherein the second member included in the paired sheet nipping members comprises a roller being rotatable.

6. The double-surface image forming apparatus of claim 2, wherein the second member included in the paired sheet nipping members comprises a spherical member being supported to be rotatable in all directions.

7. The double-surface image forming apparatus of claim 1, wherein the rotation center nipping section includes:
the paired sheet nipping members to nip the recording sheet which has arrived at the predetermined position to be rotated, and
a sheet releasing member to release the recording sheet from being nipped,
wherein when the recording sheet, conveyed to the predetermined section, is stopped, the rotation center nipping section nips the recording sheet, and after the recording sheet is rotated 180°, the rotation center nipping section releases the recording sheet by a movement of the sheet releasing member.

8. The double-surface image forming apparatus of claim 7, wherein the first member of the paired sheet nipping members comprises a rounded-point top member.

9. The double-surface image forming apparatus of claim 6, wherein the first member of the paired sheet nipping members comprises a sharp top member.

10. The double-surface image forming apparatus of claim 7, wherein the first member of the paired sheet nipping members comprises a rotatable member supported rotatably in a sheet surface direction of the sheet being rotated.

11. The double-surface image forming apparatus of claim 7, wherein the first member of the paired sheet nipping members comprises a spherical member which is supported to rotate in all directions.

12. The double-surface image forming apparatus of claim 7, wherein the second member of the paired sheet nipping members comprises a still member.

13. The double-surface image forming apparatus of claim 1, wherein the sheet rotating section is arranged upstream or downstream of the sheet reversing section in the sheet conveying direction,
wherein when the recording sheet is conveyed to the predetermined position of the sheet rotating section, the positive rotation conveying section, the positive-negative rotation conveying section, and the rotation center nipping section are configured to be arranged to meet the center of the recording sheet in the sheet conveying direction of the recording sheet to be conveyed to the predetermined position, or to be arranged at a position which is downstream of the position of the center of the recording sheet.

14. The double-surface image forming apparatus of claim 1, wherein the sheet rotating section is arranged within the sheet reversing section,
wherein when the recording sheet is conveyed to the predetermined position of the sheet rotating section, the positive rotation conveying section, the positive-negative rotation conveying section, and the rotation center nipping section are arranged to meet the center of the recording sheet in the sheet conveying direction.
